(19) United States
(12) Patent Application Publication
(10) Pub. No.: US 2002/0143976 A1
(43) Pub. Date: Oct. 3, 2002

(54) Method and system for managing and updating metadata associated with digital assets

(75) Inventors: Reed A. Barker, Decatur, GA (US); Timothy H. Addington, Roswell, GA (US)

Correspondence Address: KING & SPALDING, 191 PEACHTREE STREET, N.E., ATLANTA, GA, 30303-1763, US

(73) Assignee: N2Broadband, Inc., Duluth, GA (US)

(21) Appl. No.: 10/093,310

(22) Filed: Mar. 7, 2002

Related U.S. Application Data
(60) Provisional application No. 60/274,748, filed on Mar. 9, 2001.

(51) Int. Cl. G06F 15/16; H04N 7/16

(52) U.S. Cl. 709/231; 725/144

(57) ABSTRACT

In a system for managing and updating metadata associated with an asset, an asset provider can associate the asset with metadata. If the asset provider wants to distribute the asset to one or more distribution endpoints, the asset provider can send an asset bundle comprising the metadata and the asset to the distribution endpoints. In the event the asset provider modifies or updates the metadata associated with the asset, the asset provider can identify which distribution endpoints are to receive the updated metadata. After identifying which distribution endpoints are to receive the updated metadata, the asset provider can send the updated metadata without manual intervention to each of these distribution endpoints. Alternatively, the metadata may be stored by a metadata administrator, and the metadata may be sent to distribution endpoints upon the metadata administrator receiving a request for the metadata from the distribution endpoints.

### PRIORITY CLAIM TO PROVISIONAL APPLICATION

This application claims benefit of priority to U.S. Provisional Application Serial No. 60/274,748 entitled “Method and System for Managing Metadata Associated With Digital Video,” filed Mar. 9, 2001. The subject matter of U.S. Provisional Application Serial No. 60/274,748 is hereby fully incorporated herein by reference.

### TECHNICAL FIELD

The present invention is generally directed to management of media content distributed by one or more asset providers to distribution endpoints for communication to subscribers. More particularly described, the present invention supports the efficient communication by an asset provider of updates to metadata describing characteristics of media content maintained for distribution by distribution endpoints.

### BACKGROUND OF THE INVENTION

In the digital cable television industry, content providers, such as Home Box Office, NBC, and Warner Bros., provide digital content (alternatively described as “media assets” or “digital assets”) to distribution endpoints, such as cable headends, for distribution to cable subscribers. However, before transmitting an asset, such as a particular television episode, to one or more cable headends, the content provider will describe the asset using metadata. This metadata is typically made available to the cable subscriber through a digital cable guide to assist the subscriber in searching or selecting a program to watch on television. Thus, a content provider will use metadata to describe the attributes of the particular episode, such as the episode's title, the names of the actors and actresses who appear in the episode, the plot of the episode, the episode's genre, the television rating of the episode, the viewing time of the episode, and any relevant copyright information about the episode. After creating the metadata for the particular asset, the content provider transmits both the asset and the metadata describing the asset to the cable headends, typically via satellite in a digital data format.

Often times, a content provider needs to change the metadata for a particular asset after it has been transmitted to a cable headend. For example, the content provider may need to change the episode's television rating to reflect new ratings standards in the television industry. Similarly, the content provider may need to change an actress's last name to reflect a name change for all episodes or series in which she appeared. In addition, it may become useful to associate new types or classes of metadata with the asset.

In conventional digital cable television systems, a content provider can change the metadata in one of two ways. First, a content provider can request that every cable headend (or “distribution endpoint”) that received the transmitted asset manually change the metadata at the cable headend. However, in allowing each cable headend to change the metadata locally, the content provider loses a significant amount of control over the changes made to the metadata. Moreover, relying on local manual edits of metadata can result in significant delays between the time the change is requested by the content provider and the time the change is actually implemented at each cable headend.

Second, in conventional digital cable television systems, the content provider can manually edit the metadata to reflect the necessary changes and then retransmit the metadata and the asset to all cable headends via satellite. However, though in this scenario the content provider is able to maintain control over the editing of the metadata, retransmitting both the metadata and the asset typically consumes a substantial amount of bandwidth.

Consequently, there is a need in the art for allowing a content provider to manage metadata locally and to maintain control over the editing of metadata. More specifically, there is a need in the art for allowing a content provider to edit metadata associated with a digital asset and efficiently transmit only the updated metadata to multiple distribution points. Similarly, there is a need in the art for implementing updated metadata efficiently at specific distribution endpoints, as specified by the content provider. Last, there is a need in the art for a metadata management system that can accommodate a steadily increasing need to change metadata quickly and efficiently as services in the digital cable television industry develop and expand, and as the number of content providers providing digital content to headends and the number of assets managed by the headends steadily increase.

### SUMMARY OF THE INVENTION

The present invention can solve the aforementioned problems by providing a system and method that can allow an asset provider to manage metadata associated with an asset and to distribute the metadata to one or more distribution endpoints. In other words, the invention can allow an asset provider to update metadata associated with an asset and to distribute the updated metadata to one or more distribution endpoints.

An asset provider can associate an asset with metadata, which can be used to describe the characteristics or attributes of the asset. In the event the asset provider wants to distribute the asset to one or more distribution endpoints, the asset provider can send an asset bundle comprising the metadata and the asset to one or more distribution endpoints.

In the event the asset provider modifies or updates the metadata associated with the asset, the asset provider can identify which distribution endpoints are to receive the updated metadata. In one aspect of the present invention, the asset provider can identify the distribution endpoints to receive the updated metadata by sending a notification message to each distribution endpoint that previously received the asset from the asset provider. In response to receiving the notification message, a distribution endpoint can send a request for the updated metadata to the asset provider.

In the alternative, in another aspect of the present invention, the asset provider can identify the distribution endpoints to receive the updated metadata by receiving a request from a distribution endpoint for updated metadata for the asset, if it is available. The request can be sent by the distribution endpoint upon the expiration of a polling interval. In response to this request, the asset provider can determine if updated metadata is available.

After identifying which distribution endpoints are to receive the updated metadata, the asset provider can send the updated metadata without manual intervention to each of these distribution endpoints. In other words, in response to a request for updated metadata, the asset provider can send the updated metadata to the one or more distribution endpoints making the request.

Various aspects of the present invention may be more clearly understood and appreciated from a review of the following detailed description of the disclosed embodiments and by reference to the drawings and claims.

### BRIEF DESCRIPTION OF THE DRAWINGS

FIG. 1 is a functional block diagram illustrating exemplary components of a system for updating and distributing metadata associated with an asset that has been distributed by an asset provider to one or more distribution endpoints.

FIG. 2 is a logic flow diagram illustrating an exemplary embodiment of a process for updating metadata associated with an asset that has been distributed by an asset provider to one or more distribution endpoints.

FIG. 3 is a logic flow diagram illustrating an exemplary sub-process or routine of FIG. 2 for preparing an asset bundle to be distributed to one or more distribution endpoints.

FIG. 4 is a logic flow diagram illustrating an exemplary sub-process or routine of FIG. 2 for unbundling an asset bundle received from an asset provider at a distribution endpoint.

FIG. 5 is a logic flow diagram illustrating an exemplary sub-process or routine of FIG. 2 for updating the metadata associated with an asset that has been distributed to one or more distribution endpoints.

FIG. 6 is a logic flow diagram illustrating an exemplary sub-process or routine of FIG. 5 for sending a notification message from an asset provider to one or more distribution endpoints when the metadata for a particular asset has been updated.

FIG. 7 is a logic flow diagram illustrating an exemplary embodiment of a process for requesting updated metadata upon the expiration of a polling interval or in response to receiving a notification message that the metadata has been updated.

FIG. 8 is a logic flow diagram illustrating an exemplary sub-process or routine of FIG. 5 for determining what metadata to send to the distribution endpoint requesting updated metadata.

FIG. 9 is a logic flow diagram illustrating an exemplary sub-process or routine of FIG. 2 for receiving updated metadata for an asset from an asset provider at a distribution endpoint.

### DETAILED DESCRIPTION OF EXEMPLARY EMBODIMENTS

Although the illustrative embodiments will be generally described in the context of the cable television industry, those skilled in the art will recognize that the present invention may be implemented in any digital content industry and for any application in which an asset and metadata describing the asset are distributed to one or more distribution endpoints and in which updated or modified metadata must be redistributed to specific distribution endpoints. More specifically, those skilled in the art will recognize that other exemplary embodiments of the present invention may be implemented for applications in which metadata is updated and automatically distributed without manual intervention to one or more distribution endpoints that require the updated metadata. Moreover, those skilled in the art will also recognize that an asset can comprise any type of media content, including and not limited to MP3 files, digital video files, digital audio or music files, and other digital media and multimedia content.

An exemplary embodiment of the present invention can comprise an asset provider that distributes one or more media assets, such as television movies, series, episodes, commercials, or a combination thereof, to one or more cable headends (or “distribution endpoints”), for further distribution to an audience, such as cable subscribers. An exemplary asset provider can comprise an asset storage device for storing such assets according to an asset identifier that the asset provider uniquely assigns to each asset. The asset provider can access the asset by using the asset identifier as a pointer to locate the asset stored at the asset storage device.

The asset provider typically uses metadata to describe the characteristics or attributes of each asset stored in the asset storage device. For example, an asset provider can use metadata to identify a television program's title, the actors and actresses who appear in the television program, the plot of the program, the program's genre, the television rating of the program, and the viewing time of the program. This metadata is eventually displayed to a cable subscriber through a user interface, such as an electronic cable program guide, and assists a user in selecting a cable television program to view.

The asset provider can use a metadata storage device, typically a digital storage medium, to store metadata and changes or updates to the metadata. An exemplary metadata storage device stores the metadata associated with each asset and the asset identifier that is uniquely assigned to that asset. Each metadata storage device is typically assigned a unique identifier, called a metadata storage device locator, to assist retrieval of metadata maintained by this storage medium.

When the asset provider is prepared to distribute assets to one or more distribution endpoints, the asset provider bundles the asset with additional information into an asset bundle for transmission via a communication medium, such as a satellite communications link. The additional information typically comprises the metadata associated with the asset, the asset identifier identifying the asset, and the metadata storage device locator. Each distribution endpoint can receive the asset bundle from the asset provider via the communication medium and can route the asset bundle to an asset manager. After unbundling the asset bundle, the asset manager stores the asset and the asset identifier received from the asset provider in an exemplary asset storage device. Additionally, the asset manager typically stores the metadata describing the asset and the asset identifier identifying the asset in an exemplary metadata cache at the distribution endpoint.

After distributing an asset and its metadata to one or more distribution endpoints, an asset provider may need to modify or update metadata associated with an asset at the asset provider and thereafter redistribute the updated metadata via a communications network to one or more distribution endpoints. After the asset provider edits and modifies the metadata for an asset, the asset provider can send a notification message to the distribution endpoints having received the asset (or certain distribution endpoints needing the updated metadata) to provide an alert that the metadata describing the asset has changed. The notification message typically comprises the asset identifier of the asset for which updated metadata is available and the metadata storage device locator, which identifies in which metadata storage device the updated metadata is stored. The metadata storage device locator can be used by both the asset provider and the distribution endpoint to locate and retrieve updated metadata for one or more assets.

In response to receiving a notification message from an asset provider, a distribution endpoint can send a request over the communication network to retrieve the updated metadata from the metadata storage device identified by the metadata storage device locator. More specifically, the asset manager located at the distribution endpoint can issue a request to receive the updated metadata from the metadata storage device identified in the notification message. The request typically comprises the distribution endpoint identifier, which identifies the distribution endpoint requesting to receive the updated metadata, and the asset identifier, identifying the asset for which updated metadata is requested. The asset identifier is used to locate the updated metadata for the asset in the metadata storage device.

In another exemplary embodiment of the present invention, the distribution endpoint can be configured to request metadata for an asset from an asset provider after a certain time period has lapsed. In response to the expiration of a polling period, the distribution endpoint can issue a request for updated metadata, if any, from the asset provider. For example, a distribution endpoint can be configured to request updated metadata for a particular asset every twenty-four hours. Thus, upon the expiration of the twenty-four hour polling period, the distribution endpoint can issue a request to receive the updated metadata for the asset from the metadata storage device identified in the distribution endpoint's metadata cache. The request typically comprises the distribution endpoint identifier, which identifies the distribution endpoint requesting to receive the updated metadata, and the asset identifier, which identifies the asset for which updated metadata is requested.

Referring now to the drawings in which like numerals represent like elements throughout the several figures, exemplary embodiments of the present invention and the illustrative operating environment will be described.

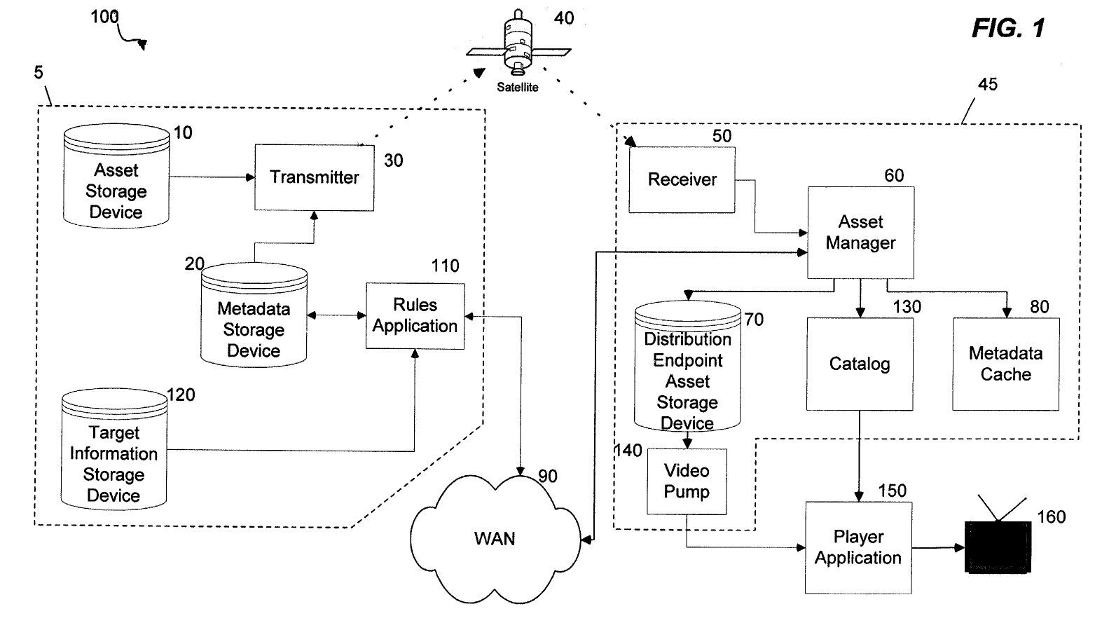

FIG. 1 is a functional block diagram illustrating exemplary components of a system 100 for updating and distributing metadata associated with an asset that has been distributed by an asset provider 5 to one or more distribution endpoints 45. Although only individual components are illustrated in the exemplary embodiment of FIG. 1, multiple components can be employed without departing from the scope and spirit of the present invention.

As shown in FIG. 1, the system 100 can comprise an asset provider 5 that distributes one or more media assets, such as television movies, series, episodes, commercials, or a combination thereof, to one or more cable headends (or “distribution endpoints”) 45, for further distribution to an audience, such as cable subscribers 160. For the representative example illustrated in FIG. 1, the assets comprise digital media content for viewing by a service subscriber. It will be appreciated by those of skill in the art that the assets can comprise video, audio, alphanumeric-based data, or a combination of video, audio or data.

The asset provider 5 can comprise an asset storage device 10 and a metadata storage device 20. The asset storage device 10 stores assets according to an asset identifier that the asset provider 5 uniquely assigns to each asset. The metadata storage device 20 stores metadata, which is used by the asset provider 5 to describe the characteristics or attributes of each asset stored in the asset storage device 10. For example, an asset provider 5 can use metadata to identify a television program's title, the actors and actresses who appear in the television program, the plot of the program, the program's genre, the television rating of the program, and the viewing time of the program. This metadata is eventually displayed to a cable subscriber 160 through a user interface, such as an electronic cable program guide, and assists a user in selecting a cable television program to view. The metadata storage device 20 can store the metadata associated with each asset and the asset identifier that is uniquely assigned to that asset. In other words, the asset identifier associates an asset with the metadata describing the asset.

Additionally, each metadata storage device 20 can be uniquely identified by a metadata storage device locator. The metadata storage device locator can be used by the asset provider 5 and the distribution endpoint 45 to locate and retrieve updated metadata stored by a particular storage device for one or more assets.

When the asset provider 5 is prepared to distribute assets to one or more distribution endpoints 45, the asset provider 5 bundles the asset, the metadata describing the asset, the asset identifier, and the metadata storage device locator into an asset bundle. The asset provider 5 can use a transmitter 30 to transmit asset bundles to one or more distribution endpoints 45. In one exemplary embodiment of the present invention, the transmitter 30 can transmit one or more asset bundles to the distribution endpoints 45 via a satellite 40. However, those skilled in the art will recognize that the asset provider 5 can distribute asset bundles to a distribution endpoint 45 via any type of wired or wireless communication medium.

A receiver 50 at the distribution endpoint 45 can receive asset bundles from the asset provider 5 via the communication medium and can route the asset bundles to an asset manager 60. The asset manager 60 receives an asset bundle from the receiver 50 and unbundles the asset bundle. Specifically, after unbundling the asset bundle, the asset manager 60 stores the asset and the asset identifier received from the asset provider 5 in an asset storage device alternatively described as a distribution endpoint storage device 70. Additionally, the asset manager 60 stores the metadata describing the asset and the asset identifier identifying the asset in a metadata cache 80.

After distributing an asset and its metadata to one or more distribution endpoints 45, an asset provider 5 may need to modify or update metadata associated with an asset at the asset provider 5 and redistribute the updated metadata to one or more distribution endpoints 45. For example, a news network that broadcasts news programming may want the metadata describing a news program updated every fifteen minutes to reflect the top five news stories for the past fifteen minutes. Similarly, an asset provider 5 may want to broadcast a commercial for the sale of a good or service related to a particular television program to a limited demographic of distribution endpoints 45 and cable subscribers 160. Additionally, an asset provider 5 may want to modify metadata to meet the system needs of a particular distribution endpoint 45 or to include local telephone numbers for advertisements for the geographic area serviced by the distribution endpoint 45.

After the asset provider 5 edits and modifies the metadata for an asset, the asset provider 5 can notify the distribution endpoints 45 having received the asset (or certain distribution endpoints 45 needing the updated metadata) that the metadata describing the asset has changed. More specifically, the asset provider 5 can create and send to certain targeted distribution endpoints 45 a notification message, which informs each distribution endpoint 45 that the metadata for a particular asset has been updated. The notification message comprises the asset identifier, which identifies the asset for which updated metadata is available, and the metadata storage device locator, which identifies the storage device in which the updated metadata is stored.

In response to receiving a notification message from an asset provider 5, a distribution endpoint 45 can send a request over a communication network 90, such as a wide area network or the Internet, for the updated metadata. More specifically, the asset manager 60 located at the distribution endpoint 45 can issue a request to receive the updated metadata from the asset provider 5 identified in the notification message. The request can comprise a distribution endpoint identifier, which uniquely identifies the distribution endpoint 45 requesting the updated metadata, the asset identifier, which uniquely identifies the asset for which updated metadata is being requested, and the metadata storage device locator for the storage device that holds the updated metadata.

In another exemplary embodiment of the present invention 100, the distribution endpoint 45 can be configured to request metadata for an asset from an asset provider 5 after a certain time period has lapsed. For example, a distribution endpoint 45 can be configured to request metadata for a particular asset or for a group of assets (perhaps categorized by type or genre of the asset or by asset provider 5 that provided the asset) using each asset's asset identifier. Thus, in the above news program example, each distribution endpoint 45 that broadcasts the news programming can be configured to request updated metadata from the asset provider every fifteen minutes. Upon the expiration of the fifteen-minute interval, the distribution endpoint 45 uses the metadata storage device locator, which is stored in the metadata cache 80, to send a request for updated metadata to the asset provider 45 via the communication medium. The request comprises the asset identifier for which the updated metadata is requested and the distribution endpoint identifier of the distribution endpoint 45 requesting the metadata. The asset provider 5 retrieves the updated metadata from the metadata storage device 10 using the asset identifier and sends the updated metadata to the distribution endpoint 45 using the distribution endpoint identifier.

The asset provider 5 can also comprise a rules application 110. The rules application 110 can receive a request for updated metadata from one or more distribution endpoints 45. The rules application 110 can use the distribution endpoint identifier included with the request to retrieve more specific information about the distribution endpoint 45 from a target information storage device 120. More specifically, before the asset provider 5 sends the distribution endpoint 45 the requested metadata, the asset provider 5 can use specific information about the distribution endpoint 45 to determine how the metadata needs to be formatted for the requesting distribution endpoint 45. The rules application 110 uses the information retrieved from the target information storage device 120 and the asset identifier to retrieve updated metadata from the metadata storage device 20.

The distribution endpoint 45 can also comprise a catalog 130, a player application 150 and a video pump 140. The catalog 130 lists, indexes, and categorizes the metadata for all the assets that are stored in the distribution endpoint asset storage device 70 and that are available to a cable subscriber 160. The player application 150 can comprise a user interface, such as an electronic program guide, that displays the assets that are available to a cable subscriber 160 and the metadata describing each asset. More specifically, the player application 150 can interact with the catalog 130 to display information about the assets to a cable subscriber 160 and to allow the cable subscriber 160 to navigate and search through the available assets using the player application 150. If a cable subscriber selects to view a particular asset using the player application 150, the player application 150 can instruct the video pump 140 to retrieve the requested asset from the distribution endpoint asset storage device 70 and route the asset to the player application 150 for display to the cable subscriber 160.

Although the metadata storage device 20, the rules application 110, and the target information storage device 120 are illustrated in FIG. 1 as being controllable or manageable by an asset provider 5, those skilled in the art will recognize that in another exemplary embodiment of the present invention, these components can be managed by a third party. In other words, another exemplary embodiment of the present invention can comprise a third party metadata administrator, which can manage metadata on behalf of one or more asset providers 5. The metadata administrator can comprise the metadata storage device 20, the rules application 110, and the target information storage device 120.

After creating metadata for an asset, the asset provider 5 can send the metadata to the metadata administrator. The metadata administrator can store the metadata and the asset identifier associated with the metadata in the metadata storage device 20 (which is uniquely identified by a metadata storage device locator). If the asset provider 5 wants to distribute the asset to one or more distribution endpoints 45, the asset provider 5 can bundle the asset, the asset identifier, and the metadata storage device locator (which identifies where the metadata associated with the asset is stored) and send the bundle to the distribution endpoints 45. Upon receiving the asset bundle from an asset provider 5, the distribution endpoint 45 can request to receive the metadata for the asset from the metadata administrator. The request can comprise a distribution endpoint identifier, which identifies the distribution endpoint 45 requesting the metadata, the asset identifier, which identifies the asset for which metadata is requested, and the metadata storage device locator, which identifies where the requested metadata is stored. In response to this request, the metadata administrator can retrieve the metadata from the metadata storage device 20 using the asset identifier and send the metadata to the distribution endpoint 45 making the request.

In another exemplary embodiment of the present invention, the distribution endpoint 45 can be configured to request the metadata for the asset upon the expiration of a polling interval. Therefore, once the polling interval expires, the distribution endpoint 45 can request the metadata for the asset from the metadata administrator.

The asset provider 5 can update or modify the metadata for an asset at any time. After updating the metadata, the asset provider 5 can send the updated metadata to the metadata administrator for distribution to the distribution endpoints 45. In one exemplary embodiment, upon receiving the updated metadata from the asset provider 5, the metadata administrator can send the updated metadata to all distribution endpoints 45 that previously received the asset. In another exemplary embodiment, the metadata administrator can issue a notification message to one or more distribution endpoints 45 that updated metadata is available for a particular asset. If a distribution endpoint 45 wants the updated metadata for the asset, the distribution endpoint 45 can send a request for the updated metadata to the metadata administrator. In response to the request, the metadata administrator can send the updated metadata to the distribution endpoint 45 identified in the request.

In another exemplary embodiment of the present invention, a metadata administrator can be responsible for managing only updated or changed metadata for one or more asset providers 5. Thus, when an asset provider 5 wants to send an asset to a distribution endpoint 45, it can bundle the asset, the asset identifier, and the metadata into an asset bundle and distribute the asset bundle to the distribution endpoints 45. If the asset provider 5 updates or modifies the metadata, the asset provider 5 can send the updated metadata and the asset identifier identifying the asset associated with the metadata to the metadata administrator. Upon receiving the updated metadata, the metadata administrator can send a notification message to one or more distribution endpoints 45 that updated metadata for the asset is available. The notification message can comprise the metadata storage device locator, which identifies the metadata storage device 20 in which the metadata for the asset is stored. If the distribution endpoint 45 wants the updated metadata, it can send a request for the updated metadata to the metadata administrator. In response, the metadata administrator can send the updated metadata to the distribution endpoint 45 identified in the request.

Additionally, although the asset manager 60 and metadata cache 80 are illustrated in FIG. 1 as being controllable or manageable by a distribution endpoint 45, those skilled in the art will recognize that in another exemplary embodiment of the present invention, these components can be managed and controlled by a third party. In other words, another exemplary embodiment of the present invention can comprise a third party metadata administrator that manages metadata on behalf of one or more distribution endpoints 45. The metadata administrator can comprise the asset manager 60 and the metadata cache 80.

After creating metadata for an asset that the asset provider 5 plans to distribute to a distribution endpoint 45, the asset provider 5 can send the metadata to the metadata administrator and the asset associated with the metadata to the distribution endpoint 45. Upon receiving the metadata from the asset provider 5, the metadata administrator can store the metadata and the asset identifier associated with the metadata in the metadata cache 80.

In one exemplary embodiment, the distribution endpoint 45 can be configured to issue, upon the expiration of a polling interval, a request to the metadata administrator for updated metadata, if it is available. In another exemplary embodiment, the distribution endpoint 45 can issue a request to receive updated metadata from the metadata administrator upon receiving a notification message that updated metadata is available.

In this way, an asset provider 5 can manage and update metadata for a particular asset locally at the asset provider 5 (or at a third party metadata administrator) without being required to re-distribute the updated metadata and the asset to every distribution endpoint 45. Additionally, in this way, a distribution endpoint 45 can request updated metadata from the asset provider 5 (or a third party metadata administrator) upon the expiration of the polling interval or in response to an update made to the metadata without requiring the asset provider 45 or metadata administrator to send both the updated metadata and the asset.

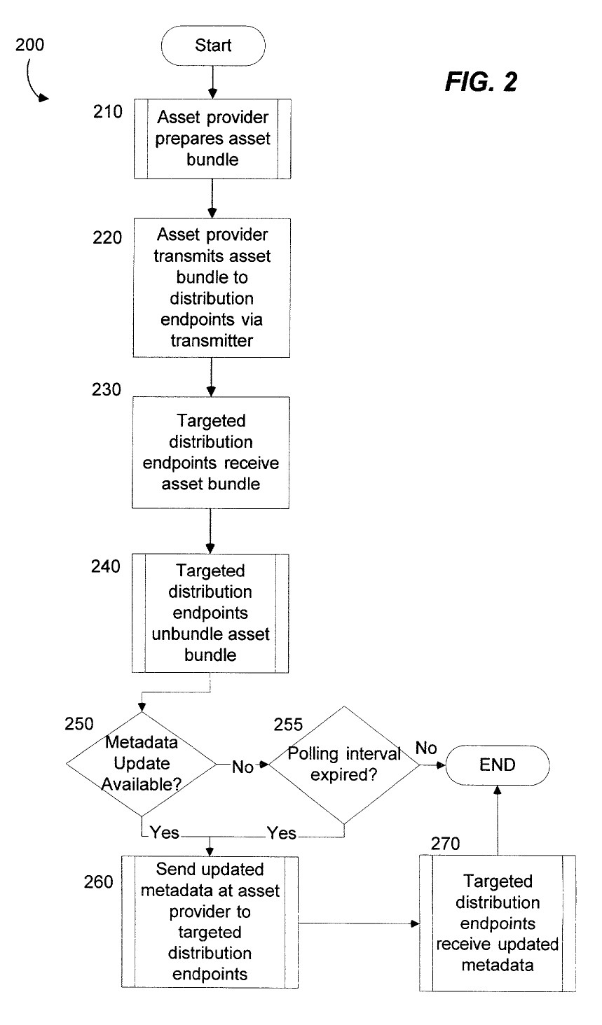

Certain steps in the processes described below in connection with FIG. 2 through FIG. 9 must naturally precede others for the present invention to function as described. However, the present invention is not limited to the order of the steps described, if such order or sequence does not alter the functionality of the present invention. It is recognized that some steps may be performed before or after other steps without departing from the scope and the spirit of the present invention.

FIG. 2 is a logic flow diagram illustrating an exemplary process 200 for updating metadata associated with an asset that has been distributed by an asset provider 5 to one or more distribution endpoints 45. More specifically, FIG. 2 illustrates an exemplary process for transmitting and updating metadata associated with an asset. Turning now to FIG. 2, step 210 is the first step in the exemplary process 200 for updating metadata associated with an asset that has been distributed by an asset provider 5 to one or more distribution endpoints 45. In Step 210, the asset provider 5 prepares an asset for distribution to one or more distribution endpoints 45. More specifically, the asset provider 5 bundles the asset with additional information before distributing the bundle to one or more distribution endpoints 45. In Step 220, the asset provider 5 distributes the asset bundle to one or more distribution endpoints 45 via the transmitter 30. In one exemplary embodiment, the asset bundle can be multicast to the distribution endpoints 45 via satellite 40. However, those skilled in the art will recognize that an asset bundle could be distributed to one or more distribution endpoints 45 over a variety of communications mediums, including, for example, the Internet or a private communications network.

In Step 230, each distribution endpoint 45 targeted to receive the asset from the asset provider 5 receives the asset bundle at the receiver 50 via the communications medium, such as via satellite 40. In Step 240, the distribution endpoint 45 unbundles the asset bundle. More specifically, the asset manager 60 receives the asset bundle from the receiver 50 and unbundles the asset bundle by parsing its content. Once the asset manager 60 has unbundled the asset bundle, the asset manager 60 stores the asset in a distribution endpoint asset storage device 70 and the metadata associated with that asset in the metadata cache 80.

In Step 250, if the asset provider 5 has modified or updated the metadata for a particular asset, the asset provider 5 sends the updated metadata in Step 260 to each distribution endpoint 45 requiring the updated metadata. Similarly, in Step 255, if a polling interval has expired and a distribution endpoint 45 has requested the updated metadata upon the expiration of the polling interval, the asset provider 5 sends the updated metadata in Step 260 to the distribution endpoints 45 for which the polling interval has expired. In Step 270, the targeted distribution endpoint 45 receives the updated metadata for the asset, as requested in response to expiration of the poling interval, from the asset provider 5.

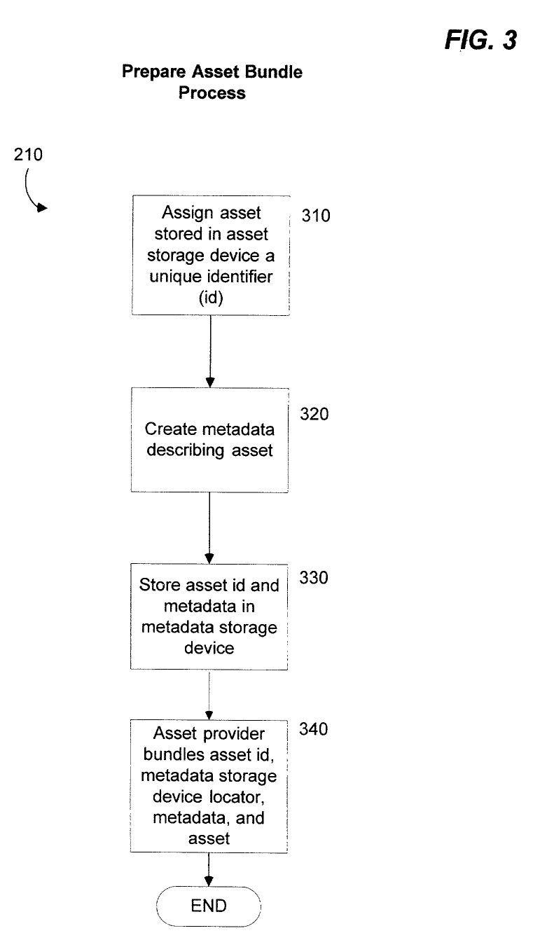

FIG. 3 is a logic flow diagram illustrating an exemplary sub-process or routine 210 of FIG. 2 for preparing an asset bundle to be distributed to one or more distribution endpoints 45. As shown in FIG. 2, Step 310 is the first step in the exemplary sub-process 210 for preparing an asset bundle to be distributed to one or more distribution endpoints 45. In Step 310, the asset provider 5 assigns an asset, which is stored in the asset storage device 10, a unique asset identifier. The asset identifier is used by the asset provider 5 and, as needed, by the distribution endpoints 45 to identify and reference a particular asset.

In Step 320, the asset provider 5 creates metadata to describe the asset. More specifically, the asset provider 5 uses metadata to describe an asset's attributes or characteristics. For example, if the asset to be distributed to the distribution endpoints 45 is a television movie, the asset provider 5 can use metadata to describe the movie's title, the actors and actresses who appear in the movie, the movie's plot, the movie's genre, the rating of the movie, and the length of the movie.

In Step 330, the asset provider 5 stores the asset identifier and the metadata in the metadata storage device 20. Each metadata storage device 20 is uniquely identified by a metadata storage device locator. Therefore, the asset provider 5 and the distribution endpoints 45 are able to locate in which metadata storage device 20 the metadata for a particular asset is stored using the metadata storage device locator and the asset identifier.

In Step 340, when the asset provider 5 is prepared to distribute the asset to one or more distribution endpoints 45, the asset provider 5 bundles the asset identifier identifying the asset, the metadata storage device locator identifying in which metadata storage device 20 the metadata for the asset is stored, the metadata describing the asset, and the asset into an asset bundle. The asset provider 5 can distribute the asset bundle to one or more distribution endpoints 45 via the satellite 40. However, those skilled in the art will recognize that the asset provider 5 can use any communication medium, including and not limited to the Internet or a private network, for distributing an asset bundle to a distribution endpoint 45.

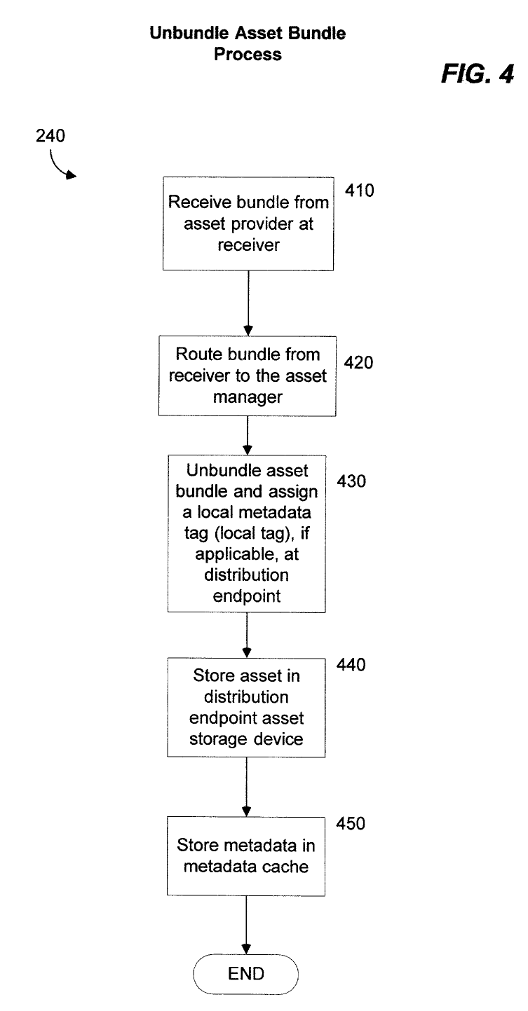

FIG. 4 is a logic flow diagram illustrating an exemplary sub-process or routine 240 of FIG. 2 for unbundling an asset bundle received by a distribution endpoint 45 from an asset provider 5. Turning now to FIG. 4, Step 410 is the first step in the exemplary sub-process 240 for unbundling the asset bundle. In Step 410, the distribution endpoint 45 receives the asset bundle from the asset provider 5 at the receiver 50 via satellite 40 or other communication medium. In Step 420, the receiver 50 routes the asset bundle to the asset manager 60 for unbundling.

In Step 430, the asset manager 60 at the distribution endpoint 45 unbundles the asset bundle and assigns a local metadata tag (or “distribution endpoint tag”), if applicable, to the asset. The distribution endpoint 45 can use the distribution endpoint tag to associate additional local information with the asset. For example, the distribution endpoint 45 can use the distribution endpoint tag to identify the geographic area and zip code of the distribution endpoint 45 or to describe the distribution endpoint's 45 system capabilities. The distribution endpoint tag is then stored in the asset manager 60.

After unbundling the asset bundle, in Step 440, the asset manager 60 stores the asset and its asset identifier in the distribution endpoint asset storage device 70. Similarly, in Step 450, the asset manager 60 stores the metadata associated with the asset, the asset identifier, and the metadata database locator in the metadata cache 80.

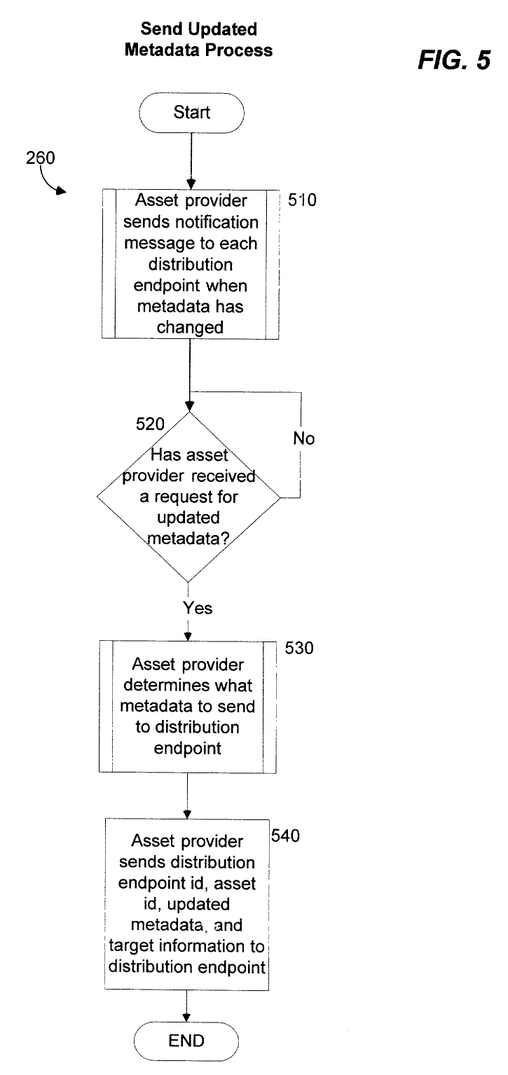

FIG. 5 is a logic flow diagram illustrating an exemplary sub-process or routine 260 of FIG. 2 for updating the metadata for an asset that has been distributed to one or more distribution endpoints 45 by the asset provider 5. Referring now to FIG. 5, Step 510 is the first step in the exemplary sub-process for updating the metadata at the asset provider 5 and distributing the updated metadata to one or more targeted distribution endpoints 45. As discussed above, asset providers 5 frequently need to change the metadata used to describe an asset after the asset and the metadata have been distributed to one or more distribution endpoints 45. For example, an asset provider 5 may want to change the order of the names of the actors and actresses for a particular asset as the actor or actress becomes more popular than his or her co-stars.

In Step 510, if the metadata for a particular asset has been changed, the asset provider 5 sends a notification message to one or more distribution endpoints 45 using the distribution endpoint identifier of each distribution endpoint 45 targeted to receive the updated metadata by the asset provider 5. This notification message informs the distribution endpoints 45 that the metadata has been updated for a particular asset. In Step 520, the asset provider 5 determines if any of the targeted distribution endpoints 45 have requested the updated metadata in response to the notification message or upon the expiration of a polling interval. If a request has been received for updated metadata from a distribution endpoint 45, in Step 530, the asset provider 5 determines what metadata to send the distribution endpoint 45 requesting the updated metadata. More specifically, the asset provider 5 uses the distribution endpoint identifier contained in the request to retrieve target information about the distribution endpoint 45 that will further assist the asset provider 5 in determining what metadata to send to the distribution endpoint 45.

In Step 540, in response to the request for updated metadata, the asset provider 5 uses the distribution endpoint identifier contained in the request to send the updated metadata to the distribution endpoint 45. More specifically, the asset provider 5 sends the distribution endpoint identifier, the asset identifier, the updated metadata associated with the asset, and any target information retrieved from the target information storage device 120 to the distribution endpoint 45 using the distribution endpoint identifier.

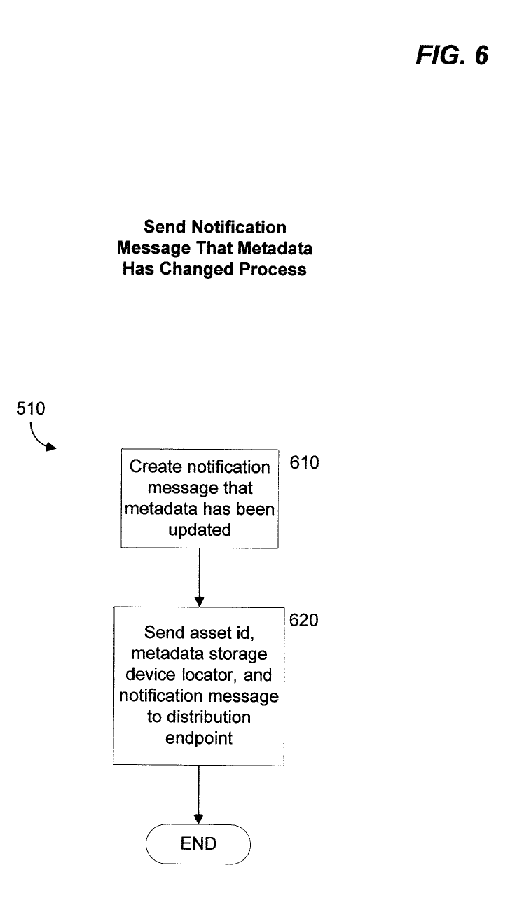

FIG. 6 is a logic flow diagram illustrating an exemplary sub-process or routine 510 of FIG. 5 for sending a notification message from an asset provider 5 to one or more distribution endpoints 45 that the metadata for a particular asset has been updated. As illustrated in FIG. 6, Step 610 is the first step in the exemplary sub-process 510 for sending the notification message to advise a target distribution endpoint of a metadata change. In Step 610, the asset provider 5 creates a notification message that metadata associated with a particular asset has been updated or modified. In Step 620, the asset provider 5 sends the asset identifier, the metadata storage device locator, and the notification message to each distribution endpoint 45 targeted by the asset provider 5 to receive the updated metadata. More specifically, the asset provider 5 uses the distribution endpoint identifiers of the distribution endpoints 45 to send the notification message to those distribution endpoints 45.

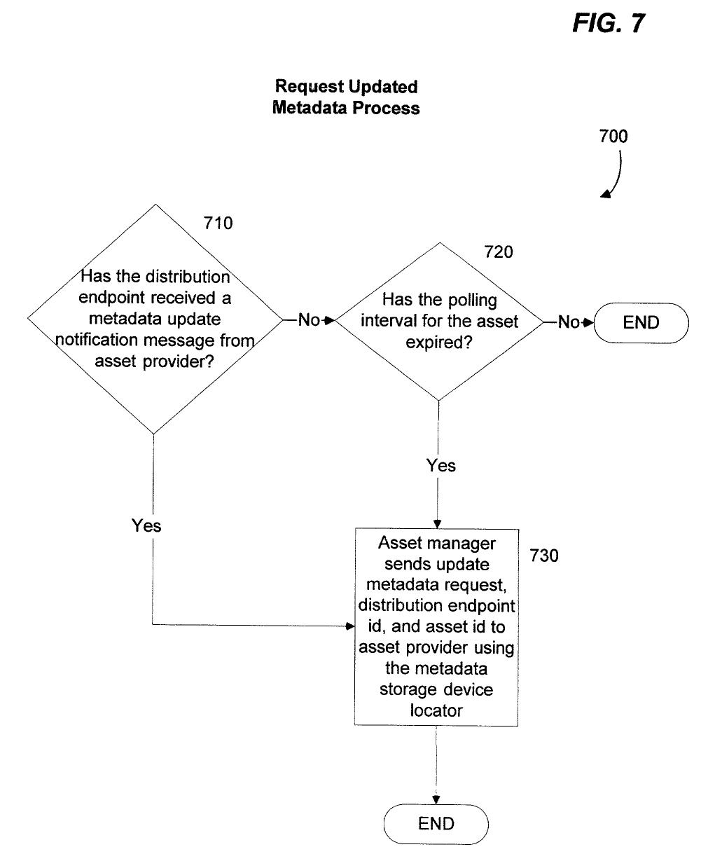

FIG. 7 is a logic flow diagram illustrating an exemplary embodiment of a process 700 for requesting updated metadata. More specifically, FIG. 7 illustrates an exemplary embodiment of a process 700 for requesting updated metadata from an asset provider 5 upon the expiration of a polling interval or in response to a distribution endpoint 45 having received a notification message that the metadata has changed. As shown in FIG. 7, Step 710 is the first step in the exemplary process 700 for requesting updated metadata. In Step 710, the distribution endpoint 45 determines whether it has received a notification message from an asset provider 5 informing the distribution endpoint 45 that metadata for a particular asset has changed. If a notification message has not been received by the distribution endpoint 45 from an asset provider 5, in Step 720, the distribution endpoint 45 determines whether a polling interval for the asset has expired. In other words, in Step 720, the distribution endpoint 45 determines if it is time to request updated metadata because a polling interval has lapsed. If the distribution endpoint 45 determines that it has received a notification message from the asset provider 5 or that a polling interval has expired, in Step 730, the asset manager 60 located at the distribution endpoint 45 sends a request for the updated metadata to the asset provider 5 using the metadata storage device locator. More specifically, the distribution endpoint 45 sends a request for updated metadata, its distribution endpoint identifier, the metadata storage device locator and the asset identifier to the asset provider 5 via a communication medium, such as a wide area network 90.

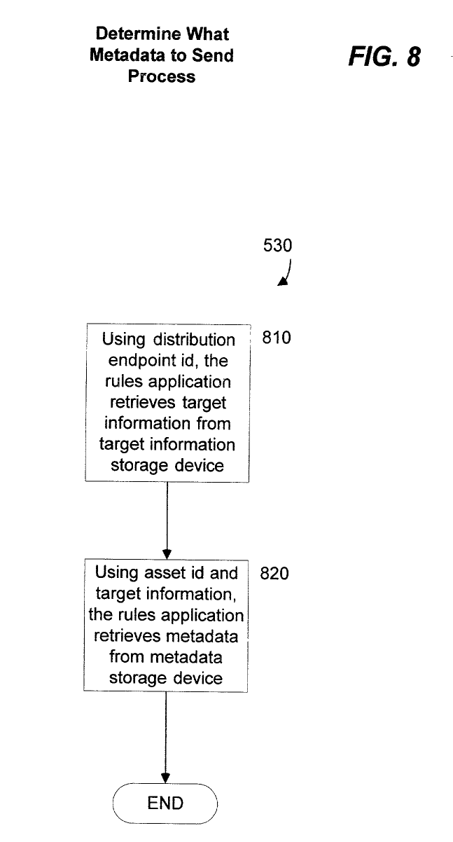

FIG. 8 is a logic flow diagram illustrating an exemplary sub-process or routine 530 of FIG. 5 for determining what metadata to send a distribution endpoint 45 requesting updated metadata. Turning now to FIG. 8, Step 810 is the first step in the exemplary sub-process 540 for selecting metadata for targeted communication to a requesting distribution endpoint. At Step 810, a rules application 110 of the asset provider 5 receives the request for updated metadata from the distribution endpoint 45. Using the distribution endpoint identifier contained in the request, the rules application 110 retrieves target information from the target information storage device 120. The target information storage device 120 stores information specific to each distribution endpoint 45 by its distribution endpoint identifier. For example, a target information storage device 120 can store such information about a distribution endpoint 45 as the geographic location of the distribution endpoint 45, vendor information about the video on demand systems used by the distribution endpoint 45, the software versions of the video on demand systems employed at the distribution endpoint 45, the vendor and version information for the catalog 130 used by the distribution endpoint 45, and specific advertiser information based on the distribution endpoint's 45 geographic location.

In Step 820, the rules application 110 uses the asset identifier and the target information retrieved from the target information storage device 120 to retrieve updated metadata for the asset from the metadata storage device 20. In one exemplary embodiment, the rules application 110 can use the target information about the distribution endpoint 45 to determine what advertisements or commercials are available for that geographic location. For example, if a local store in zip code 30303 is running a commercial for a special promotion, the rules application 110 can use the target information to determine whether a particular distribution endpoint 45 services zip code 30303 and therefore should receive that local commercial.

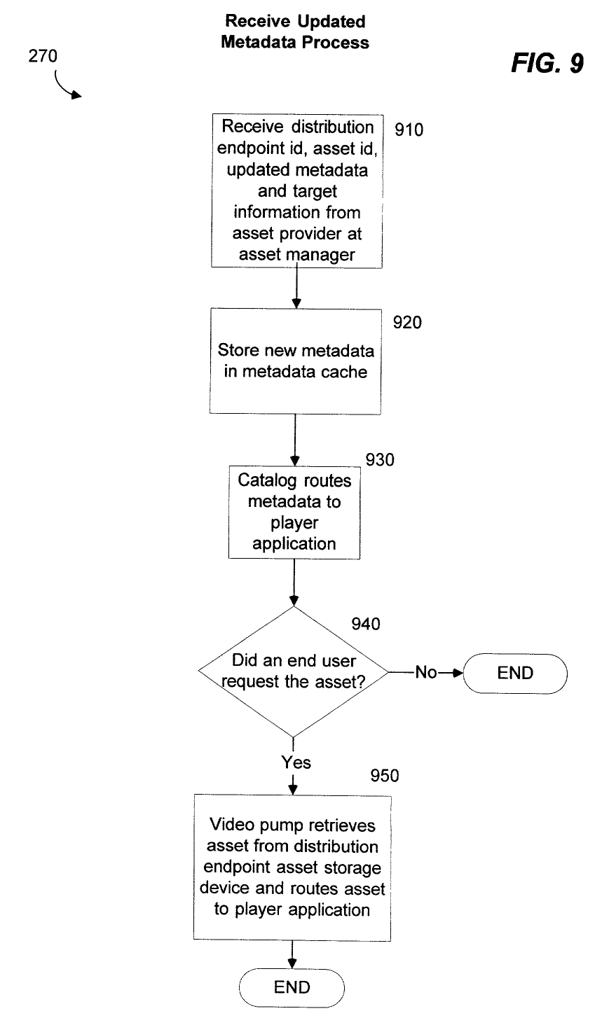

FIG. 9 is a logic flow diagram illustrating an exemplary sub-process or routine 270 of FIG. 2 for receiving updated metadata for an asset from an asset provider 5. Referring now to FIG. 9, Step 910 is the first step in the exemplary process 270 for receiving updated metadata at a distribution endpoint 45. In Step 910, the distribution endpoint 45 receives the distribution endpoint identifier, the asset identifier, the updated metadata, and the target information from the asset provider 5 at the asset manager 60 via a communication medium, such as a wide area network 90 or a private network. In Step 920, the asset manager 60 stores the updated metadata and the target information for that asset identifier in the metadata cache 80.

In Step 930, the catalog 130 receives the updated metadata from the asset manager 60 and routes the updated metadata to the player application 150. The catalog 130 lists, indexes, and categorizes the metadata for all the assets that are stored in the distribution endpoint asset storage device 70 and that are available to a cable subscriber 160. The player application 150 can comprise a user interface, such as an electronic program guide, that displays the assets that are available to a cable subscriber 160 and the metadata describing each asset. Thus, the player application 150 can interact with the catalog 130 to display information about the assets to a cable subscriber 160 and to allow the cable subscriber 160 to navigate and search through the available assets using the player application 150.

In Step 940, the distribution endpoint 45 determines whether a cable subscriber 160 has requested to view the asset. If the cable subscriber 160 has requested to view the asset, in Step 950, the video pump 140 verifies that the cable subscriber 160 is authorized to view the requested asset. If the cable subscriber 160 is authorized to view the asset, the video pump 140 retrieves the asset from the distribution endpoint asset storage device 70 and routes the asset to the player application 150 for viewing by the cable subscriber 160.

Those skilled in the art will appreciate that the processes and the architecture of the exemplary embodiment of the present invention allows an asset provider to manage metadata locally and to maintain control over the editing of metadata. Additionally, those skilled in the art will appreciate that the processes and the architecture of the exemplary embodiment of the present invention allows an asset provider to distribute updated metadata efficiently to targeted distribution endpoints as specified by the asset provider. Last, those skilled in the art will recognize that the processes and architecture of the exemplary embodiment can accommodate a steadily increasing need to modify metadata efficiently as services in the cable industry continue to develop and expand and rely upon the efficient modification and distribution of metadata associated with digital assets.

It should be understood that the foregoing relates only to illustrative embodiments of the present invention, and that numerous changes may be made therein without departing from the scope and spirit of the invention as defined by the following claims.

What is claimed is:

1. A method for managing metadata associated with an asset that is distributed by an asset provider to at least one distribution endpoint, comprising the steps of:
associating the asset with metadata that describes the asset;
sending an asset bundle comprising the metadata and the asset to the at least one distribution endpoint; and
in response to a change to the metadata describing the asset,
identifying each distribution endpoint to receive the changed metadata; and
sending the changed metadata without manual intervention to each identified distribution endpoint.

2. The method of managing metadata of claim 1, wherein the asset bundle further comprises an asset identifier that uniquely identifies the asset and a metadata storage device locator that identifies a metadata storage device operative to store the metadata and the asset identifier for each asset.

3. The method for managing metadata of claim 2, wherein the associating step further comprises the steps of:
assigning to the asset the asset identifier;
creating the metadata that describes the asset; and
storing the metadata and the asset identifier in the metadata storage device, wherein the metadata associated with the asset can be accessed at the metadata storage device by use of the asset identifier assigned to the asset.

4. The method for managing metadata of claim 2, wherein the identifying step comprises the steps of:
responsive to the change in the metadata associated with the asset, sending a notification message from the asset provider to the at least one distribution endpoint that has previously received the asset; and
in response to receiving the notification message, transmitting a request for the changed metadata from the at least one distribution endpoint to the asset provider, the request comprising the metadata storage device locator.

5. The method of managing metadata of claim 4, wherein the notification message comprises the asset identifier that identifies the asset for which the metadata has changed and the metadata storage device locator that identifies the metadata storage device where the changed metadata for the asset is stored.

6. The method of managing metadata of claim 4, wherein the request comprises the asset identifier that identifies the asset for which the changed metadata is requested and a distribution endpoint identifier that identifies the distribution endpoint requesting to receive the changed metadata.

7. The method for managing metadata of claim 2, further comprising the steps of:
for each distribution endpoint identified to receive changed metadata,
retrieving target information for the distribution endpoint using a distribution endpoint identifier that identifies the distribution endpoint, the target information comprising specific information about the distribution endpoint, and
using the target information and the asset identifier, retrieving the changed metadata from the metadata storage device identified by the metadata storage device locator.

8. The method for managing metadata of claim 2, further comprising retrieving the changed metadata from the metadata storage device using the metadata storage device locator to identify where the changed metadata is stored and the asset identifier to identify the asset associated with the changed metadata.

9. The method for managing metadata of claim 6, wherein the identifying step comprises:
issuing a request from the distribution endpoint upon the expiration of a polling interval to determine if updated metadata for the asset is available, the request comprising the metadata storage device locator and the distribution endpoint identifier that identifies the distribution endpoint; and
responsive to the request, determining whether updated metadata for the asset is available by accessing the metadata storage device identified by the metadata storage device locator.

10. The method for managing metadata of claim 1, further comprising the steps of:
receiving the asset bundle from the asset provider at the distribution endpoint; and
associating the asset with a distribution endpoint tag that further describes the asset using descriptors that are local to the distribution endpoint.

11. A method for updating metadata associated with an asset that is distributed by an asset provider to at least one distribution endpoint comprising the steps of:
associating the asset with metadata that describes the asset, a polling interval that defines when the distribution endpoint should request an update to the metadata, and a metadata storage device locator that identifies a storage device in which the metadata is stored on behalf of the asset provider;
sending an asset bundle comprising the metadata, the asset, the metadata storage device locator, and the polling interval to each distribution endpoint;
upon expiration of the polling interval, issuing a request from the distribution endpoint to determine if updated metadata for the asset is available, the request comprising the metadata storage device locator and a distribution endpoint identifier that identifies the distribution endpoint;
responsive to the request, determining whether updated metadata for the asset is available by accessing the metadata storage device identified by the metadata storage device locator; and
if updated metadata for the asset is available, sending the updated metadata to the distribution endpoint identified in the request by using the distribution endpoint identifier.

12. The method for updating metadata of claim 11, wherein the asset bundle further comprises an asset identifier assigned to the asset that uniquely identifies the asset.

13. The method for updating metadata of claim 12, wherein the associating step further comprises the steps of:
assigning to the asset the asset identifier;
creating the metadata that describes the asset; and
storing the metadata and the asset identifier in the metadata storage device.

14. The method for updating metadata of claim 12, wherein the issuing step comprises electronically sending the request to the asset provider associated with the metadata storage device identified by the metadata storage device locator, the request further comprising the asset identifier to support access to updated metadata associated with the asset and stored by the metadata storage device.

15. The method for updating metadata of claim 12, further comprising the steps of:
retrieving target information for the distribution endpoint identified by the request, the target information comprising specific information about the distribution endpoint; and
using the target information and the asset identifier, retrieving the updated metadata from the metadata storage device identified by the metadata storage device locator.

16. The method for managing metadata of claim 11, further comprising the steps of:
receiving the asset bundle from the asset provider at the distribution endpoint; and
associating the asset of the asset bundle with a distribution endpoint tag that further describes the asset using descriptors that are local to the distribution endpoint.

17. The method for managing metadata of claim 12, wherein the determining step further comprises using the asset identifier to access the metadata storage device to determine whether updated metadata is available for the asset.

18. A method of updating metadata describing an asset that has been distributed with corresponding metadata to at least one distribution endpoint, comprising the steps of:
sending a notice notifying each distribution endpoint having received the asset that an update for the metadata associated with the asset is available for receipt by the distribution endpoint, the notice comprising a metadata storage device locator for retrieving the updated metadata from a metadata storage device identified by the metadata storage device locator;
responsive to the notice, sending a request for the updated metadata from the distribution endpoint, the request comprising a distribution endpoint identifier for identifying the distribution endpoint and the metadata storage device locator;
responsive to the request, retrieving the updated metadata for the asset from the metadata storage device identified by the metadata storage device locator; and
transmitting the updated metadata to the distribution endpoint identified by the distribution endpoint identifier.

19. A system for managing metadata associated with a media asset comprising:
an asset provider, operative to send the media asset identified by an asset identifier and corresponding metadata to at least one distribution endpoint, wherein the asset provider comprises:
a transmitter, operative to send the media asset and the metadata to each distribution endpoint and to send a notification message when the metadata associated with the media asset by the asset identifier has been changed by the asset provider,
a metadata storage device, coupled to the transmitter, operative to store the metadata and any change to the metadata; and
each distribution endpoint, comprising:
a receiver, operative to receive the media asset and the corresponding metadata from the asset provider, and
an asset manager, coupled to the receiver, operative to respond to the receipt of the notification message from the asset provider by generating a request for the changed metadata from the asset provider.

20. The system for managing metadata of claim 19, wherein the asset provider further comprises an asset storage device, coupled to the transmitter, operative to store the media asset.

21. The system of managing metadata of claim 19, wherein the asset provider further comprises:
a rules application, responsive to receipt of the request for changed metadata from the distribution endpoint, operative to retrieve the changed metadata for transmission to the requesting distribution endpoint; and
a target information storage device, coupled to the rules application, operative to store target information describing specific attributes of each of the distribution endpoints.

22. A distribution endpoint operative to manage changes to metadata associated with at least one media asset, comprising:
a receiver, operative to receive the media asset and the metadata describing attributes of the media asset, wherein the metadata further comprises a polling interval that defines when the distribution endpoint should request an update to the metadata; and
an asset manager, coupled to the receiver, operative to request the updated metadata for the media asset upon the expiration of the polling interval, wherein the receiver is further operative to receive the updated metadata in the event that the updated metadata is available for distribution to the distribution endpoint.

23. An asset provider, operative to manage changed metadata associated with at least one media asset, comprising:
a metadata storage device, operative to store the changed metadata associated with the media asset; and
a rules application, coupled to the metadata storage device, operative to distribute the changed metadata.

24. The asset provider of claim 23, further comprising a transmitter, coupled to the metadata storage device, operative to send a notification message in the event the metadata associated with the asset has been changed.

25. A method of distributing updated metadata describing an asset to at least one distribution endpoint, comprising the steps of:
changing the metadata associated with the asset and storing the changed metadata in a metadata storage device that is identified by a metadata storage device locator;
for each distribution endpoint that received the asset, sending a notification notifying the distribution endpoint that the metadata has been changed;
upon receiving the notification that the metadata has changed for the asset, issuing a request from the distribution endpoint for the changed metadata, the request comprising the metadata storage device locator and a distribution endpoint identifier identifying the distribution endpoint; and
in response to the request for changed metadata made by the distribution endpoint, sending the changed metadata to the distribution endpoint identified by the distribution endpoint identifier.

26. A method for managing metadata associated with an asset that is maintained for use by at least one distribution endpoint, comprising the steps of:
receiving the metadata that is associated with the asset;
identifying each distribution endpoint that has access to the asset as an identified distribution endpoint to receive the metadata; and
sending the metadata without manual intervention to each identified distribution endpoint.

27. The method for managing metadata of claim 26, further comprising the step of storing the received metadata and an asset identifier identifying the asset associated with the metadata in a metadata storage device that is identified by a metadata storage device locator.

28. The method for managing metadata of claim 27, wherein the identifying step comprises the steps of:
sending a notification message to the at least one distribution endpoint that has previously received the asset in a separate communication from the asset provider, wherein the notification message comprises the asset identifier that identifies the asset for which metadata is available, and the metadata storage device locator that identifies the metadata storage device where the metadata is stored; and
determining if, in response to the notification message, the distribution endpoint has issued a request to receive the metadata, the request comprising the asset identifier that identifies the asset for the requested metadata, the metadata storage device locator, and a distribution endpoint identifier that identifies the distribution endpoint issuing the request.

29. The method for managing metadata of claim 28, further comprising the steps of:
in response to receiving the request, retrieving target information for the distribution endpoint using the distribution endpoint identifier that identifies the distribution endpoint, the target information comprising information describing attributes of the distribution endpoint, and
using the target information and the asset identifier, retrieving the metadata from the metadata storage device identified by the metadata storage device locator.

30. The method for managing metadata of claim 27, wherein the identifying step comprises:
receiving a request from the distribution endpoint upon the expiration of a polling interval to determine if metadata for the asset is available, the request comprising the metadata storage device locator and the distribution endpoint identifier that identifies the distribution endpoint; and
responsive to the request, determining whether metadata for the asset is available by accessing the metadata storage device identified by the metadata storage device locator.

31. The method for managing metadata of claim 27, further comprising the step of retrieving the metadata from the metadata storage device using the metadata storage device locator to identify where the metadata is stored and the asset identifier to identify the asset associated with the metadata.

32. The method for managing metadata of claim 28, wherein the identifying step comprises receiving a request for the metadata from the at least one distribution endpoint, the request comprising the asset identifier that identifies the asset for the requested metadata, the metadata storage device locator, and the distribution endpoint identifier that identifies the distribution endpoint issuing the request.

33. The method for managing metadata of claim 26, wherein each identified distribution endpoint receives the asset in a communication that is separate from a distribution of the metadata.

34. A method for managing metadata at a distribution endpoint, wherein the metadata is associated with an asset that is maintained at a location other than the distribution endpoint, comprising the steps of:
receiving at the distribution endpoint the metadata that describes the asset and a metadata storage device locator that identifies a storage device for storing the metadata at a location other than the distribution endpoint;
issuing a request to determine if updated metadata for the asset is available for use by the distribution endpoint, the request comprising the metadata storage device locator and a distribution endpoint identifier that identifies the distribution endpoint issuing the request for the updated metadata; and
if the updated metadata for the asset is available, then receiving the updated metadata at the distribution endpoint identified by the distribution endpoint identifier.

35. The method for managing metadata of claim 34, wherein the issuing step comprises electronically sending the request upon the expiration of a polling interval.

36. The method of managing metadata of claim 34, wherein the issuing step comprises electronically sending the request in response to receiving a notification message that updated metadata is available for the asset.

37. The method of managing metadata of claim 36, the notification message comprising the metadata storage device locator useful for retrieving the updated metadata from the metadata storage device identified by the metadata storage device locator.

38. A method for managing metadata associated with an asset that is maintained for use by at least one distribution endpoint, comprising the steps of:
receiving the metadata that is associated with the asset;
receiving a request for the metadata from the at least one distribution endpoint; and
sending the metadata without manual intervention to the at least one distribution endpoint.

39. The method for managing metadata of claim 38, further comprising the step of storing the received metadata and an asset identifier identifying the asset associated with the metadata in a metadata storage device that is identified by a metadata storage device locator.

40. The method for managing metadata of claim 39, wherein the request comprises the asset identifier that identifies the asset for the requested metadata, the metadata storage device locator identifying the metadata storage device where the metadata is stored, and a distribution endpoint identifier that identifies the distribution endpoint issuing the request.

41. The method for managing metadata of claim 38, wherein the request is received from the distribution endpoint upon the expiration of a polling interval to determine if metadata for the asset is available.

42. The method for managing metadata of claim 40, further comprising the steps of:
in response to receiving the request, retrieving target information for the distribution endpoint using the distribution endpoint identifier that identifies the distribution endpoint, the target information comprising information describing attributes of the distribution endpoint; and
using the target information and the asset identifier, retrieving the metadata from the metadata storage device identified by the metadata storage device locator.

43. The method for managing metadata of claim 39, further comprising the step of retrieving the metadata from the metadata storage device using the metadata storage device locator to identify where the metadata is stored and the asset identifier to identify the asset associated with the metadata.

44. The method for managing metadata of claim 38, wherein each identified distribution endpoint receives the asset in a communication that is separate from a distribution of the metadata.
